(19) United States
(12) Patent Application Publication
(10) Pub. No.: US 2009/0254717 A1
(43) Pub. Date: Oct. 8, 2009

(54) STORAGE SYSTEM AND METHOD THEREOF

(75) Inventors: Ing-Shry Kuo, Hsinchu City (TW); Andrew C. Chang, Hsinchu City (TW); Shih-Chung Tu, Taipei Country (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/098,482

(22) Filed: Apr. 7, 2008

(51) Int. Cl. G06F 12/00

(52) U.S. Cl. 711/154; 711/E12.001

(57) ABSTRACT

A storage system and a method thereof. The storage system comprises first and second storage devices, first and second analog front ends, and a controller. The first and second analog front ends, coupled to the first and second storage devices, receive first and second analog data from the first and second drive devices for conversion to first and second digital data. The controller, coupled to the first and second analog front ends, comprises a signal processor and a common memory. The signal processor receives the first and second digital data to perform first and second digital signal processing and access the common memory. The common memory is coupled to the signal processor to be accessed thereby.

### BACKGROUND OF THE INVENTION

1. Field of the Invention

The invention relates to data storage, and in particular to a data storage system and method thereof.

2. Description of the Related Art

In a computer system, data is stored in storage devices such as a hard disk and CD/DVD drives. To accommodate different applications and data, multiple storage devices are utilized in a computer system so that a host computer can access data in different formats. Since data is recorded in different data formats for different storage devices, each storage device employs a specific controller to control dataflow between the storage device and the host computer. This approach, however, consumes both software and hardware resources, thus a need exists for a storage system and method thereof to reduce system complexity and manufacturing cost.

### BRIEF SUMMARY OF THE INVENTION

A detailed description is given in the following embodiments with reference to the accompanying drawings.

According to the invention, a storage system comprises first and second storage devices, first and second analog front ends, and a controller. The first and second analog front ends, coupled to the first and second storage devices, receive first and second analog data from the first and second drive devices for conversion to first and second digital data. The controller, coupled to the first and second analog front ends, comprises a signal processor and a common memory. The signal processor receives the first and second digital data to perform first and second digital signal processing and access the common memory. The common memory is coupled to the signal processor to be accessed thereby.

According to the invention, a method in a storage system comprises first and second analog front ends receiving first and second analog data from first and second storage devices for conversion to first and second digital data, a controller receiving the first and second digital data to perform first and second digital signal processing according to the data type, and the controller accessing the processed first and second digital data in a common memory.

### BRIEF DESCRIPTION OF THE DRAWINGS

The invention can be more fully understood by reading the subsequent detailed description and examples with references made to the accompanying drawings, wherein:

FIG. 1 is a block diagram of a conventional storage system.

FIG. 2 is a block diagram of an exemplary storage system according to the invention.

FIG. 3 is a block diagram of another exemplary storage system according to the invention.

FIG. 4 is a block diagram of yet another exemplary storage system according to the invention.

FIG. 5 is a block diagram of still another exemplary storage system according to the invention.

FIG. 6 is a block diagram of another exemplary storage system according to the invention.

FIG. 7 is a block diagram illustrating the operation of the access matrix incorporated in FIGS. 2 through 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

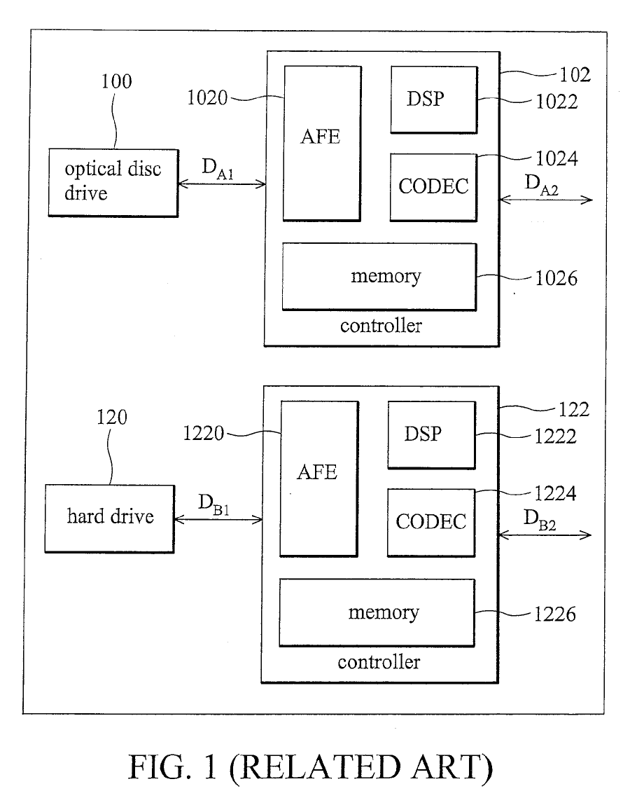

FIG. 1 is a block diagram of a conventional storage system, comprising optical disc drive 100, controller 102, hard drive 120, and controller 122. Disc drive 100 is coupled to controller 102, and hard drive 120 is coupled to controller 122. Controller 102 comprises analog front end (AFE) 1020, digital signal processor (DSP) 1022, encoder/decoder (CODEC) 1024, and memory 1026. Similarly, controller 122 comprises AFE 1220, DSP 1222, CODEC 1224, and memory 1226.

Each storage drive requires a dedicated controller to control dataflow and access data therein. Since disc drive 100 and hard drive 120 access data in different formats, controllers 102 and 122 utilize separate AFE, DSP, CODEC, and memory to process the data, all components cannot be shared, such that cost to build the conventional storage system is high.

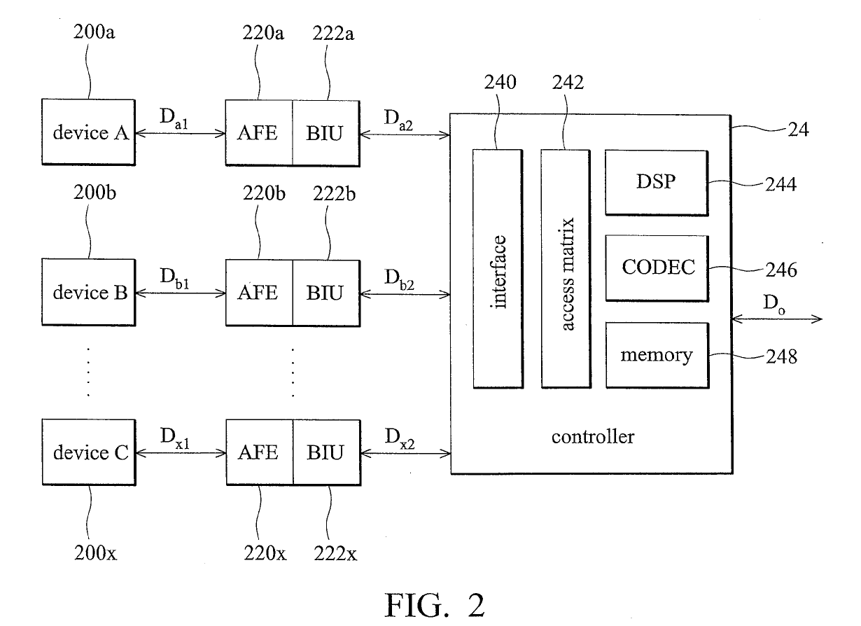

FIG. 2 is a block diagram of an exemplary storage system according to the invention, comprising device A 200a, device B 200b, device C 200x, AFEs 220a, 220b, and 220x, bus interface unit (BIU) 222a, 222b, and 222c, and controller 24. Controller 24 comprises interface 240, access matrix 242, DSP 244, CODEC 246 and memory 248.

In the storage system in FIG. 2, the analog front end circuits are separated from the controller. The controller integrates all digital signal processes therein to perform digital data operations for all data formats, enables a host computer (not shown) to access data in the storage devices, and shares a common memory 248 during the operations, thereby reducing circuit dimension and complexity.

Device A 200a, device B 200b, and device C 200x may be magnetic storage such as hard disks, optical storage such as CD ROM, electrical storage such as non-volatile memory cards, or a combination thereof.

AFEs 220a, 220b, and 220x and controller 24 are located on separate ICs so that controller 24 can integrate digital signal processors, encoders/decoders, and memory onto a single IC and share the hardware resources.

AFEs 220a, 220b, and 220x receives analog data Da1, Db1, and Dx1 from devices 200a, 200b, and 200x for conversion to digital data Da2, Db2, and Dx2, transformed by BIU 222a, 222b, and 222x to a predetermined data format.

Interface 240 may be serial or parallel. Access matrix 242 provides digital data Da2, Db2, and Dx2 and control signals to AFEs 220a, 220b, and 220x through interface 240. Access matrix 242 also provides paths to direct digital data Da2, Db2, and Dx2 between storage devices 200a, 200b, and 200x, increasing input/output performance of the disclosed storage system. Access matrix 242 may be implemented by multiplexers or a crossbar switch.

DSP 244 performs digital signal processing on data Da2, Db2, and Dx2. The digital signal processing may be mathematical operations depending on the target applications.

CODEC 246 encodes and decodes the data Da2, Db2, and Dx2 with predetermined scheme to provide encoded and decoded data for the target applications. For example, the predetermined encoding/decoding scheme may be EFM/EFM+ (Eight-to-Fourteen Modulation/Eight-to-Fourteen Modulation Plus) for CDs and DVDs. In a decoding process, CODEC 246 generates decoded data Da2, Db2, and Dx2 to DSP 244 based on the data format thereof. Conversely, in an encoding process, CODEC 246 receives the processed data from DSP 244 for encoding to an appropriate data format to be stored in storage devices in an encoding process.

Memory 248 provides temporary data storage for data Da2, Db2, and Dx2 during digital signal processing and encoding/decoding processing, concurrently or separately, so that memory requirement is reduced. Consequently, the storage system in FIG. 2 offers increased utilization rate, decreased circuit complexity, decreased manufacturing cost, and reduced power consumption requirement in comparison to the conventional system.

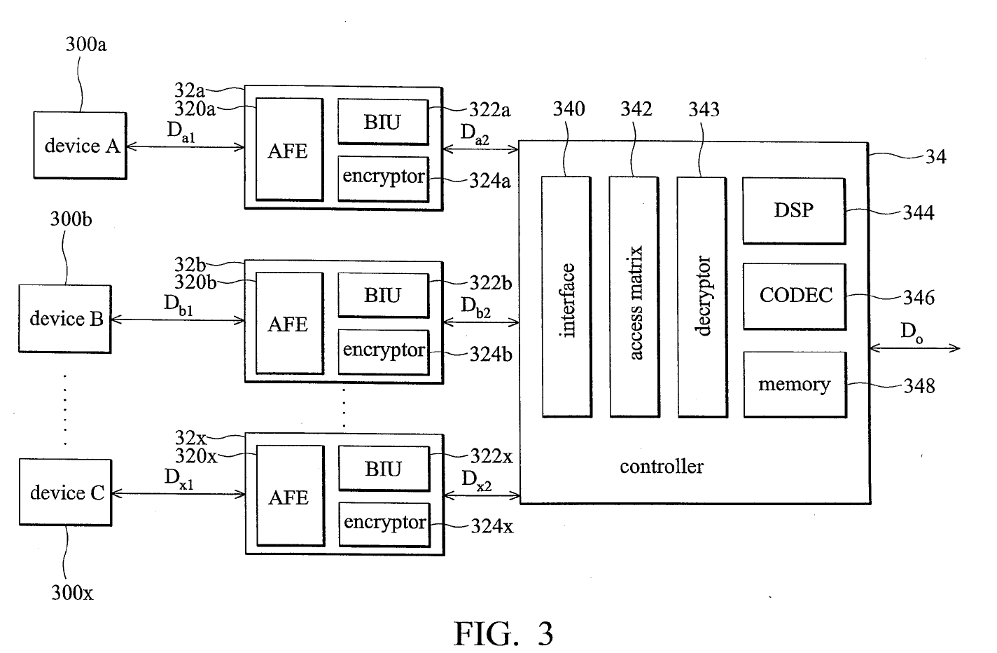

FIG. 3 is a block diagram of another exemplary storage system according to the invention, comprising device A 300a, device B 300b, device C 300x, AFE circuits 32a, 32b, and 32x, and controller 34. Devices 300a, 300b, and 300x are coupled to controller 34 through AFE circuits 32a, 32b, and 32x. AFE circuit 32a comprises AFE 320a, BIU 322a, and encryptor 324a. Likewise, AFE circuit 32b comprises AFE 320b, BIU 322b, and encryptor 324b, and AFE circuit 32x comprises AFE 320x, BIU 322x, and encryptor 324x. Controller 34 comprises interface 340, access matrix 342, decryptor 343, DSP 344, CODEC 346 and memory 348.

The implementation and operation of the analog front ends, bus interface units, interface, access matrix, DSP, CODEC, and memory in FIG. 3 can refer to the description in FIG. 2.

Encryptors 324a, 324b, and 324x encrypt digital data Da2, Db2, and Dx2 to provide increased data security against illegal copying during data transmission between BIUs and controllers. Decryptor 343 is provided in controller 34 to decrypt encrypted data Da2, Db2, and Dx2 correspondingly. The encryption and decryption may be different or identical for digital data Da2, Db2, and Dx2.

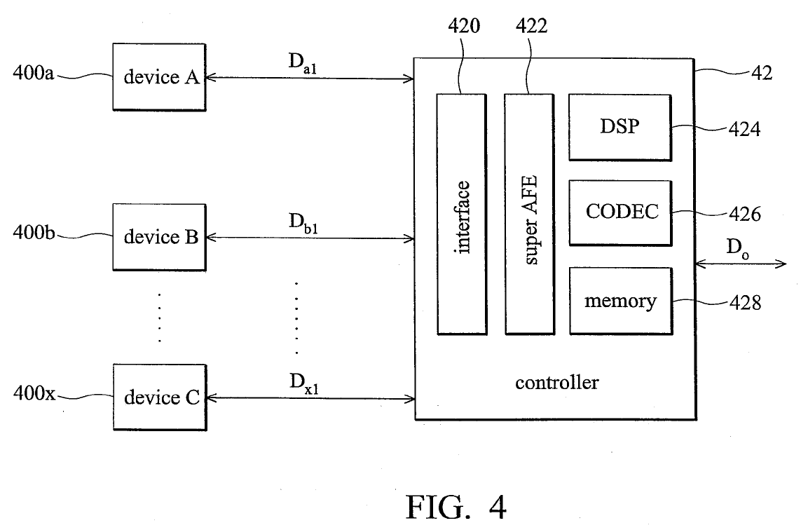

FIG. 4 is a block diagram of yet another exemplary storage system according to the invention, comprising device A 400a, device B 400b, device C 400x, and controller 42. Devices 400a, 400b, and 400x are coupled to controller 42 in parallel. Controller 42 comprises interface 420, super analog front end (SAFE) 422, DSP 424, CODEC 426 and memory 428.

FIG. 4 shows controllers for all storage devices integrated in a single IC, such that data interfaces, including BIUs and data matrix are no longer required. The implementation and operation of the DSP, CODEC, and memory in FIG. 4 can refer to the description in FIG. 2.

Controller 42 integrates analog front ends for analog data Da1, Db1, and Dx1 to super AFE 422 to provide digital data conversion. SAFE 422 receives data Da1, Db1, and Dx1 through interface 420 and generates digital data according to data type of data Da1, Db1, and Dx1. In comparison to the storage in FIG. 2, since the AFEs are integrated into single controller IC 42, bus interface units 222a, 222b, and 222x and access matrix 242 are no longer implemented, resulting in reduced manufacturing cost and system complexity.

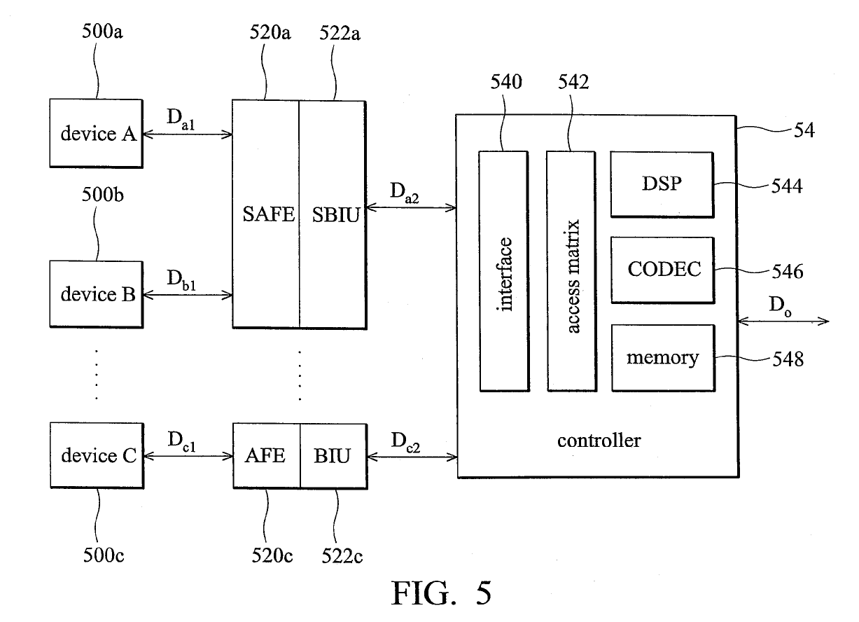

FIG. 5 is a block diagram of still another exemplary storage system according to the invention, comprising device A 500a, device B 500b, device C 500x, SAFE 520a, SBIU 522a, AFE 520c, BIU 522c, and controller 54. Devices 500a, and 500b are coupled to controller 54 through SAFE 520a and SBIU 522a. Device 500c is coupled to controller 54 through AFE 520c and BIU 522c. Controller 54 comprises interface 540, access matrix 542, DSP 544, CODEC 546, and memory 548.

For simplicity, please refer to descriptions for FIG. 2, which shows implementation and operation of AFE, BIU, interface, access matrix, DSP, CODEC, and memory.

Devices 500a and 500b share common SAFE 520a and super BIU 522a to convert analog data Da1 and Db1 to digital data Da2. Device 500c utilizes AFE 520c and BIU 522c to provide digital data Dc2 to controller 54. The combination of SAFEs and AFEs in the storage system enhances flexibility and scalability of the system.

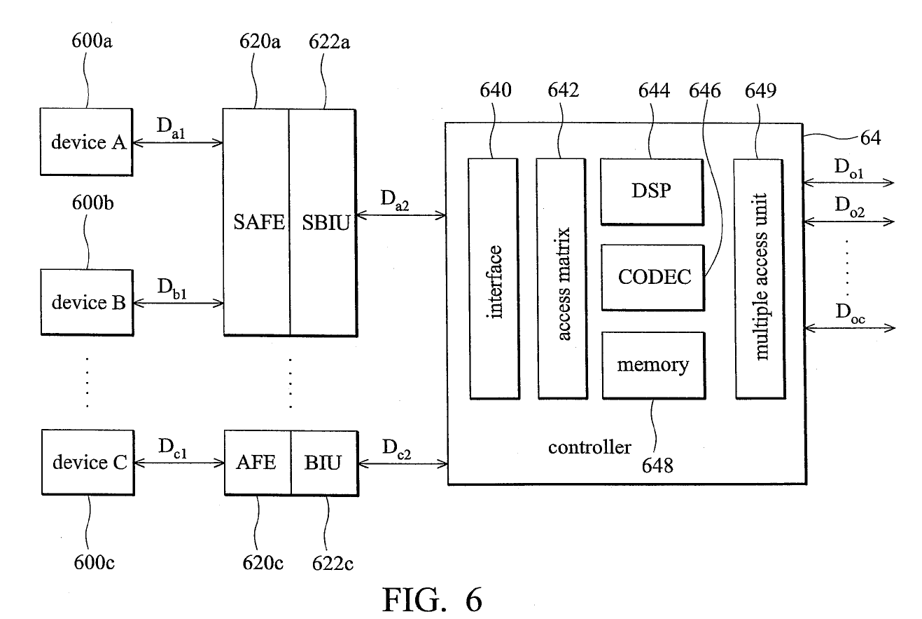

FIG. 6 is a block diagram of another exemplary storage system according to the invention, comprising device A 600a, device B 600b, device C 600c, SAFE 620a, SBIU 622a, AFE 620c, BIU 622c, and controller 64. Devices 600a, and 600b are coupled to controller 64 through SAFE 620a and SBIU 622a. Device 600c is coupled to controller 64 through AFE 620c and BIU 622c. Controller 64 comprises interface 640, access matrix 642, DSP 644, CODEC 646, memory 648, and multiple access unit 649.

A host system accesses data in storage devices 600a, 600b, and 600c, concurrently or separately through multiple access unit 649, allowing multiple computer applications to be performed concurrently and increasing hardware and software utilization. The multiple data accesses may be wired or wireless.

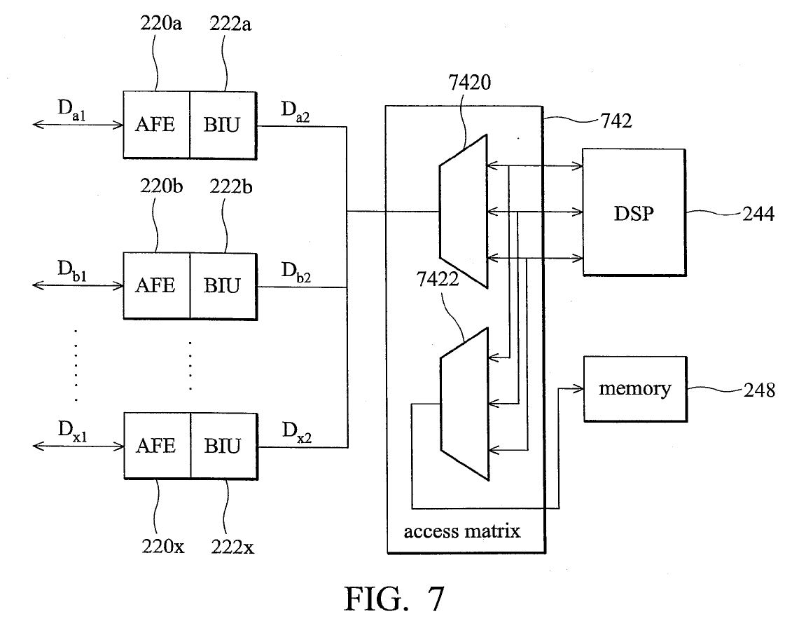

FIG. 7 is a block diagram illustrating the operation of the access matrix incorporated in FIGS. 2 through 6, comprising multiplexers 7420 and 7422.

Access matrix 742 comprises the multiplexers to direct dataflow between the AFEs and the DSP, and between the DSP and the memory. For example, when the host system reads data from the storage devices, digital data Da2, Db2, Dx2 are passed to DSP 244 for signal processing, multiplexer 7420 controls dataflow therebetween, such that DSP 244 can perform DSP operation according to the data type. In DSP/encoding/decoding processes, multiplexer 7422 controls intermediate data to be buffered in memory 248 temporary for later usage, allowing shared memory for signal processing of data Da2, Db2, and Dx2.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A storage system, comprising:
first and second storage devices;
first and second analog front ends, coupled to the first and second storage devices, receiving first and second analog data from the first and second storage devices for conversion to first and second digital data; and
a controller, coupled to the first and second analog front ends, comprising:
a signal processor, receiving the first and second digital data to perform first and second digital signal processing according to the data type, and accessing the processed first and second digital data in a common memory; and
the common memory, coupled to the signal processor to be accessed thereby.

2. The storage system of claim 1, wherein the first and second analog front ends further comprise first and second encryptors encrypting the first and second digital data, and the controller further comprises first and second decryptors decrypting the encrypted first and second digital data.

3. The storage system of claim 1, wherein the first and second analog front ends and the controller are on separate integrated circuits.

4. The storage system of claim 1, wherein the first and second analog front ends and the controller are on one integrated circuit.

5. The storage system of claim 1, wherein the controller further comprises an access matrix directing the first and second digital data to the digital signal processor.

6. The storage system of claim 1, wherein the controller further comprises a multiple access unit providing multiple data accesses concurrently.

7. The storage system of claim 1, wherein the controller further comprises a CODEC, coupled to the signal processor and the first and second analog front ends, receiving the processed first and second digital data to perform encoding or decoding thereon.

8. A method in a storage system, comprising:
first and second analog front ends receiving first and second analog data from first and second storage devices for conversion to first and second digital data;
a controller receiving the first and second digital data to perform first and second digital signal processing according to the data type; and
the controller accessing the processed first and second digital data in a common memory.

9. The method of claim 8, further comprising:
first and second encryptors encrypting the first and second digital data; and
first and second decryptors in the controller decrypting the encrypted first and second digital data.

10. The method of claim 8, wherein the first and second analog front ends and the controller are on separate integrated circuits.

11. The method of claim 8, wherein the first and second analog front ends and the controller are on one integrated circuit.

12. The method of claim 8, further comprising a multiple access unit accessing the first and second storage devices concurrently.

13. The method of claim 8, further comprising a CODEC receiving the processed first and second digital data to perform encoding or decoding.
